(19) United States
(12) Patent Application Publication
(10) Pub. No.: US 2008/0235163 A1
(43) Pub. Date: Sep. 25, 2008

(54) SYSTEM AND METHOD FOR ONLINE DUPLICATE DETECTION AND ELIMINATION IN A WEB CRAWLER

(76) Inventors: Srinivasan Balasubramanian, Madurai (IN); Rajesh M. Desai, San Jose, CA (US); Piyoosh Jalan, San Jose, CA (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/689,551

(22) Filed: Mar. 22, 2007

(51) Int. Cl. G06F 17/00

(52) U.S. Cl. 706/12; 707/3; 707/7; 707/E17.007

(57) ABSTRACT

As part of the normal crawling process, a crawler parses a page and computes a de-tagged hash, called a fingerprint, of the page content. A lookup structure consisting of the host hash (hash of the host portion of the URL) and the fingerprint of the page is maintained. Before the crawler writes a page to a store, this lookup structure is consulted. If the lookup structure already contains the tuple (i.e., host hash and fingerprint), then the page is not written to the store. Thus, a lot of duplicates are eliminated at the crawler itself, saving CPU and disk cycles which would otherwise be needed during current duplicate elimination processes.

### BACKGROUND

1. Field of the Invention

The embodiments of the invention provide a system, method, etc. for online duplicate detection and elimination in a web crawler.

2. Description of the Related Art

A web crawler is a software program that fetches web pages from the Internet. It parses outlinks from the fetched pages and follows those discovered outlinks. This process is repeated to crawl the “entire” web. The crawler is typically seeded with a few well know sites from where it keeps discovering new outlinks and keeps crawling them.

When a page is requested to a web-server, it returns a hypertext transfer protocol (http) return code in the response header along with the content of the page. The following provides a brief description of the various http return codes as described by http protocol. First, the success return code 2xx provides that the action was successfully received, understood, and accepted. Second, the redirection return code 3xx provides that further action must be taken in order to complete the request. Next, the client error return code 4xx provides that the request contains bad syntax or cannot be fulfilled. Further, the server error return code 5xx provides that the server failed to fulfill an apparently valid request.

Duplicate pages on the web pose problems for applications such as web search engines, web data mining, and text analytics. Because of the enormous size of the web, the problem becomes even harder to deal with. The duplicate pages impact the data quality and performance of the system. The poor data quality resulting from duplicate pages skews the mining and sampling properties in the system. Moreover, duplicate pages also results in wastage of system resources such as processing cycles and storage.

A large percentage of duplicate pages for a given site are often high frequency duplicate pages. High frequency duplicate pages are identical pages appearing several times on the site. A large number of web-servers return a valid page with a 200 return code for invalid, outdated or unavailable links, displaying a standard error page. These error pages have some custom message like “File Not found” instead of any valid content. In theory, a web-server should return an actual error code (>300) for a non-existing page instead of a page with a 200 return code displaying a custom message. These pages with a custom error message and 200 return code are referred to as soft 404 pages. A large number of web-servers display a soft 404 page to report invalid, unavailable, or broken links.

FIG. 1 illustrates a pie chart showing duplicate distribution of pages on the web. The analysis was done on sample web data consisting of about 3.5 billion pages. About 36.3% (˜1.28 billion) of sample pages were duplicates. The duplicates are classified as top N pages, meaning N pages with the same content, where N=3,5,10.

When only top 3 site level duplicates are considered across a sample web corpus of 3.5 billion pages, they constitute about 20% of all duplicates. While the average page size on the web is around 20 K bytes, the average page size of the top 3 duplicates is only 179 bytes. Further analyzing the content of these top 3 duplicate pages identifies that they are soft 404 pages with some small custom message.

For applications like search engine and those in the category of web data mining, the typical data flow cycle is illustrated in FIG. 2. The data fetched by the crawler is stored, then different data cleaning techniques are applied before data is indexed and/or mined. Duplicate pages are eliminated during the data cleaning phase. However, eliminating duplicate pages in the data cleaning phase results in wastage of processing cycles and storage. A method is needed to detect and eliminate high frequency duplicate pages during the crawling phase itself. Detecting and eliminating high frequency duplicate pages at crawl time can save significant CPU cycles for processing and disk space for storing such pages.

### SUMMARY

The embodiments of the invention provide methods, systems, etc. for online duplicate detection and elimination in a web crawler. More specifically, a method begins by following at least one link contained in a first document to locate a plurality of second documents, wherein the first document and the second documents are accessible through a computerized network. The computerized network could be the Internet and the documents could be electronic documents, web pages, or websites.

Next, each of the second documents is parsed into content and location information; and, hypertext markup language (HTML) tags of the document are removed. The content is hashed to produce a content file for each of the second documents; and, the location information is also hashed to produce a location file for each of the second documents. Following this, the content file and the location file are combined into a combination file for each of the second documents to produce a plurality of combination files. The combining of the content file and the location file can include eliminating the creation of partially constructed mirror sites.

The combination files are compared to identify duplicate second documents. This can include storing a first combination file in a lookup structure and determining if a subsequent combination file is in the lookup structure. The duplicate second documents are subsequently eliminated. This can include eliminating duplicate custom error documents, wherein the duplicate custom error documents comprise a similar content, a similar content provider (host site), and a different uniform resource locator (URL).

The method further comprises storing second documents that are not duplicates. Moreover, the method indexes the second documents that are stored, wherein the storing and the indexing can be performed during a crawling process. Additionally, data mining is performed upon the second documents that are stored.

A system is also provided comprising a browser that follows at least one link contained in a first document to locate a plurality of second documents, wherein the first document and the second documents are accessible through a computerized network. The computerized network could be the Internet and the documents could be electronic documents or websites. A parser is operatively connected to the browser, wherein the parser parses each of the second documents into content and location information. Moreover, a hasher is operatively connected to the parser, wherein the hasher hashes the content to produce a content file for each of the second documents. The hasher also hashes the location information to produce a location file for each of the second documents and removes HTML tags of the document.

The system also includes a processor operatively connected to the hasher, wherein the processor combines the content file and the location file into a combination file for each of the second documents to produce a plurality of combination files. A comparator is operatively connected to the processor, wherein the comparator compares the combination files to identify duplicate second documents. Further, a filter is operatively connected to the comparator, wherein the filter eliminates the duplicate second documents. The filter also eliminates the creation of partially constructed mirror sites and eliminates duplicate custom error documents, wherein the duplicate custom error documents comprise a similar content, a similar content provider (host site), and a different URL.

Additionally, a memory is operatively connected to the filter, wherein the memory stores second documents that are not duplicates. The memory and the indexer can perform the storing and the indexing during a crawling process. Moreover, the memory and the comparator can store a first combination file in a lookup structure and determine if a subsequent combination file is in the lookup structure.

Further, an indexer is operatively connected to the memory, wherein the indexer indexes the second documents that are stored. A data miner is operatively connected to the indexer, wherein the data miner performs data mining upon the second documents that are stored.

Accordingly, as part of the normal crawling process, a crawler parses a page and computes a de-tagged hash, called a fingerprint, of the page content. A lookup structure consisting of the host hash (hash of the host portion of the URL) and the fingerprint of the page is maintained. Before the crawler writes a page to a store, this lookup structure is consulted. If the lookup structure already contains the tuple (i.e., host hash and fingerprint), then the page is not written to the store. Thus, a lot of duplicates are eliminated at the crawler itself, saving CPU and disk cycles which would otherwise be needed during current duplicate elimination processes.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a pie chart illustrating duplicate distribution of pages on the web;

FIG. 2 is a diagram illustrating a data flow cycle for a web data mining application;

FIG. 3 is a diagram illustrating a system for online duplicate detection and elimination in a web crawler;

FIG. 4 is a diagram illustrating a method for online duplicate detection and elimination in a web crawler;

FIG. 5 is a diagram illustrating a system for online duplicate detection and elimination in a web crawler; and

FIG. 6 is a diagram illustrating another method for online duplicate detection and elimination in a web crawler.

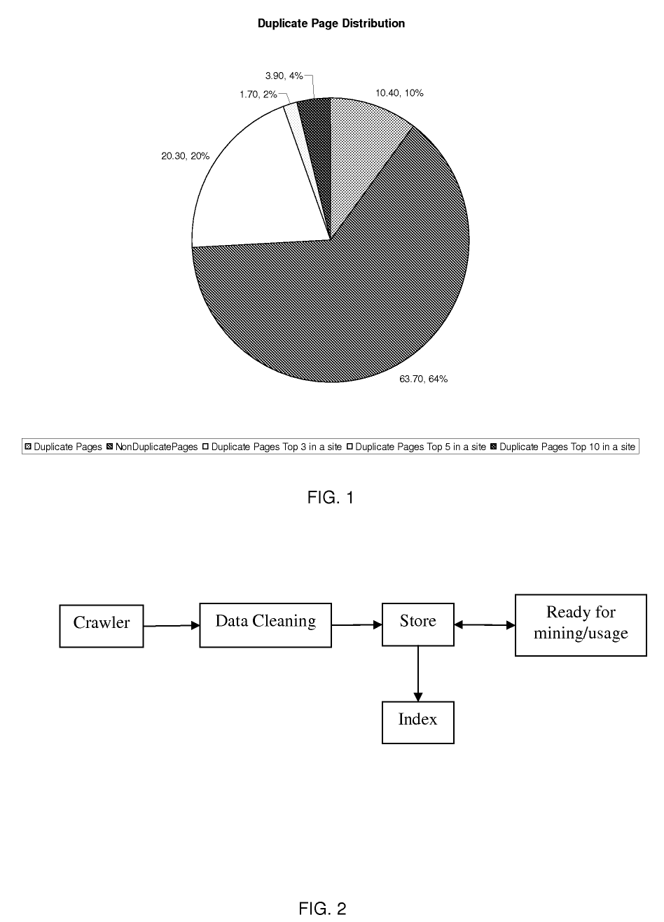

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As part of the normal crawling process, a crawler parses a page and computes a de-tagged hash, called a fingerprint, of the page content. A lookup structure consisting of the host hash (hash of the host portion of the URL) and the fingerprint of the page is maintained. Before the crawler writes a page to a store, this lookup structure is consulted. If the lookup structure already contains the tuple (i.e., host hash and fingerprint), then the page is not written to the store. Thus, a lot of duplicates are eliminated at the crawler itself, saving CPU cycles and disk I/O which would otherwise be needed during current duplicate elimination processes.

The essence of considering (host hash, fingerprint) tuple in duplicate detection at crawl time is that it avoids construction of partially mirrored sites in a backend repository. For example, there are two sites which are mirror/partial mirrors of each other. The crawler detects those and starts to crawl independent parts of the sites. If the cross site duplicate detection is implemented, then both the sites may be partially crawled, wherein some parts are declared as duplicates of the other. Embodiments herein independently crawl both the mirror sites completely, wherein only the duplicate pages are removed from the same host.

In summary, the tuple consisting of the host hash and fingerprint is used instead of just the fingerprint to do the checks. If just the fingerprint of the page were used, it would have arbitrarily eliminated a lot of cross page duplicates, thereby resulting in incoherent data.

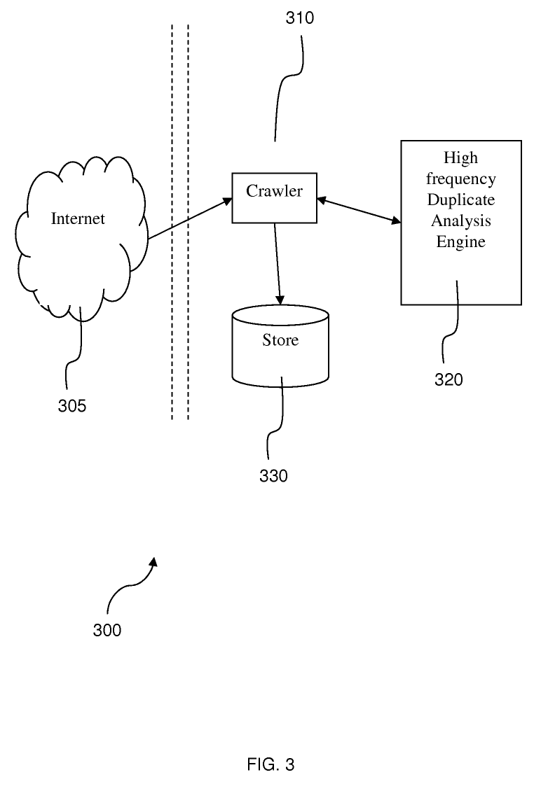

FIG. 3 illustrates a system 300 for online duplicate detection and elimination in a web crawler 310. The high frequency duplicate analysis engine 320 maintains a lookup structure consisting of a host hash, fingerprint tuple. After a page from the Internet 305 is crawled and before it is written to the store 330, the crawler 310 sends the fingerprint and host hash to the high frequency duplicate analysis engine 320. When the engine 320 sees a tuple for the first time, it stores the tuple in its lookup structure. If the tuple is already present, the engine 320 responds back indicating the presence of a similar page to the crawler 310. Upon receiving the indication, the crawler 310 doesn't write that page to the store 330, thereby reducing amount of data the downstream engine 320 has to process.

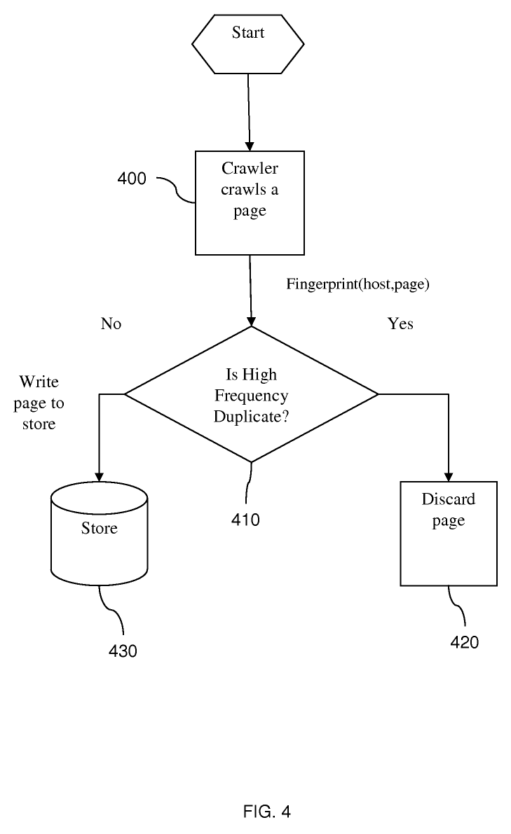

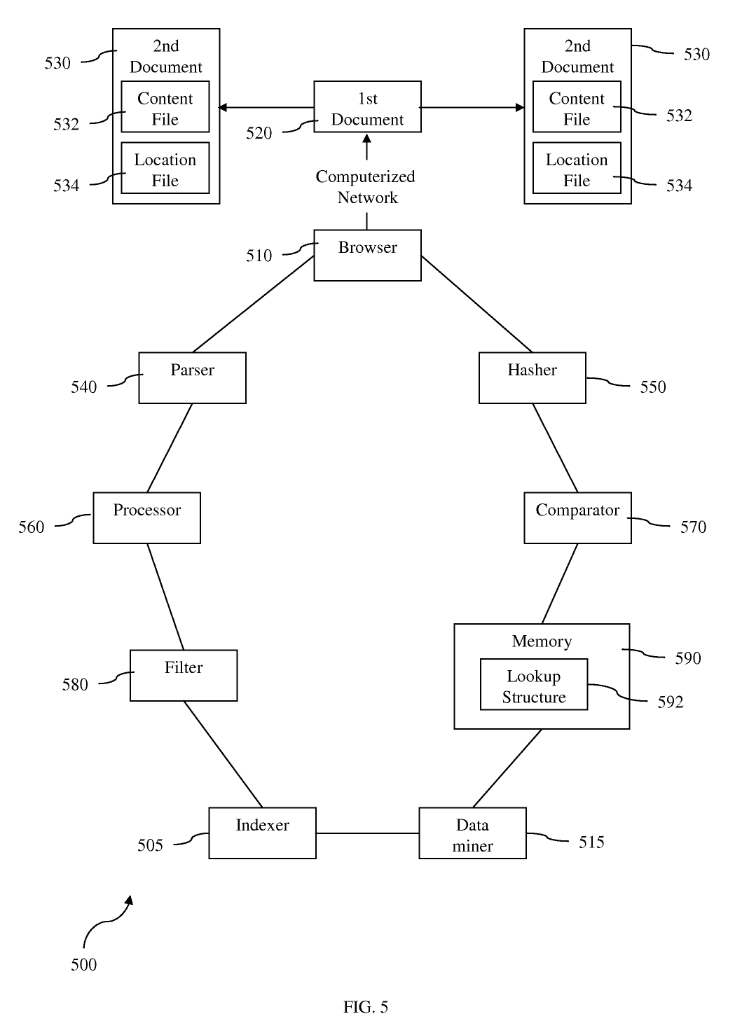

FIG. 4 illustrates a method of online duplicate detection and elimination in a web crawler. In item 400, the crawler crawls a page. Next, in item 410, the method determines whether the page is a duplicate. If the page is a duplicate, the page is discarded in item 420. If the page is not a duplicate, the page is written to a store in item 430.

Accordingly, the embodiments of the invention provide methods, systems, etc. for online duplicate detection and elimination in a web crawler. More specifically, a method begins by following at least one link contained in a first document to locate a plurality of second documents, wherein the first document and the second documents are accessible through a computerized network. The computerized network could be the Internet and the documents could be electronic documents or websites. Each of the second documents is then parsed into content and location information; and, HTML tags of the document are removed.

Next, the content is hashed to produce a content file (also referred to herein as a “fingerprint”) for each of the second documents. The location information (host part of the URL) is also hashed to produce a location file (also referred to herein as a “host hash”) for each of the second documents. Following this, the content file and the location file are combined into a combination file (also referred to herein as a “tuple”, i.e., a tuple of the hosthash and fingerprint) for each of the second documents to produce a plurality of combination files. As described above, the tuple consisting of the host hash and fingerprint is used instead of just the fingerprint to do the checks. If just the fingerprint of the page were used, it would have arbitrarily eliminated a lot of cross page duplicates, thereby resulting in incoherent data.

The combining of the content file and the location file can include eliminating the creation of partially constructed mirror sites. As described above, the essence of considering (host hash, fingerprint) tuple in duplicate detection at crawl time is that it avoids construction of partially mirrored sites in a backend repository. For example, there are two sites which are mirror/partial mirrors of each other. The crawler detects those and starts to crawl independent parts of the sites. If the cross site duplicate detection is implemented, then both the sites may be partially crawled, wherein some parts are declared as duplicates of the other. Embodiments herein independently crawl both the mirror sites completely, wherein only the duplicate pages are removed from the same host.

The combination files are compared to identify duplicate second documents. This can include storing a first combination file in a lookup structure and determining if a subsequent combination file is in the lookup structure. As described above, before the crawler writes a page to a store, this lookup structure is consulted. If the lookup structure already contains the tuple (i.e., host hash and fingerprint), then the page is not written to the store. Thus, a lot of duplicates are eliminated at the crawler itself, saving CPU and disk cycles which would otherwise be needed during current duplicate elimination processes. The duplicate second documents are subsequently eliminated. This can include eliminating duplicate custom error documents, wherein the duplicate custom error documents comprise a similar content, a similar content provider (host site), and a different URL.

The method further includes storing ones of the second documents that are not duplicate second documents. Moreover, the method indexes the ones of the second documents that are stored, wherein the storing and the indexing can be performed during a crawling process. Additionally, data mining is performed upon the ones of the second documents that are stored.

A system 500 is also provided comprising a browser 510 that follows at least one link contained in a first document 520 to locate a plurality of second documents 530, wherein the first document 520 and the second documents 530 are accessible through a computerized network. The computerized network could be the Internet and the documents could be electronic documents or websites. A parser 540 is operatively connected to the browser 510, wherein the parser 540 parses each of the second documents 530 into content and location information. Moreover, a hasher 550 is operatively connected to the parser 540, wherein the hasher 550 hashes the content to produce a content file 532 (also referred to herein as a “fingerprint”) for each of the second documents 530 and removes the HTML tags of the document. The hasher 550 also hashes the location information to produce a location file 534 (also referred to herein as a “host hash”) for each of the second documents 530.

The system 500 also includes a processor 560 operatively connected to the hasher 550, wherein the processor 560 combines the content file 532 and the location file 534 into a combination file (also referred to herein as a “tuple”) for each of the second documents 530 to produce a plurality of combination files. As described above, the tuple consisting of the host hash and fingerprint is used instead of just the fingerprint to do the checks. If just the fingerprint of the page were used, it would have arbitrarily eliminated a lot of cross page duplicates, thereby resulting in incoherent data. A comparator 570 is operatively connected to the processor 560, wherein the comparator 570 compares the combination files to identify duplicate second documents 530.

Further, a filter 580 is operatively connected to the comparator 570, wherein the filter 580 eliminates the duplicate second documents 530. The filter 580 also eliminates the creation of partially constructed mirror sites and eliminates duplicate custom error documents, wherein the duplicate custom error documents comprise a similar content, a similar content provider (host site), and a different URL. As described above, the essence of considering (host hash, fingerprint) tuple in duplicate detection at crawl time is that it avoids construction of partially mirrored sites in a backend repository. For example, there are two sites which are mirror/partial mirrors of each other. The crawler detects those and starts to crawl independent parts of the sites. If the cross site duplicate detection is implemented, then both the sites may be partially crawled, wherein some parts are declared as duplicates of the other. Embodiments herein independently crawl both the mirror sites completely, wherein only the duplicate pages are removed from the same host.

Additionally, a memory 590 is operatively connected to the filter 580, wherein the memory 590 stores the second documents 530 that are not duplicates. The memory 590 and the indexer 505 can perform the storing and the indexing during a crawling process. Moreover, the memory 590 and the comparator 570 can store a first combination file in a lookup structure 592 and determine if a subsequent combination file is in the lookup structure 592. As described above, before the crawler writes a page to a store, this lookup structure 592 is consulted. If the lookup structure 592 already contains the tuple (i.e., host hash and fingerprint), then the page is not written to the store. Thus, a lot of duplicates are eliminated at the crawler itself, saving CPU and disk cycles which would otherwise be needed during current duplicate elimination processes.

Further, an indexer 505 is operatively connected to the memory 590, wherein the indexer 505 indexes the second documents 530 that are stored. A data miner 515 is operatively connected to the indexer 505, wherein the data miner 515 performs data mining upon the second documents 530 that are stored.

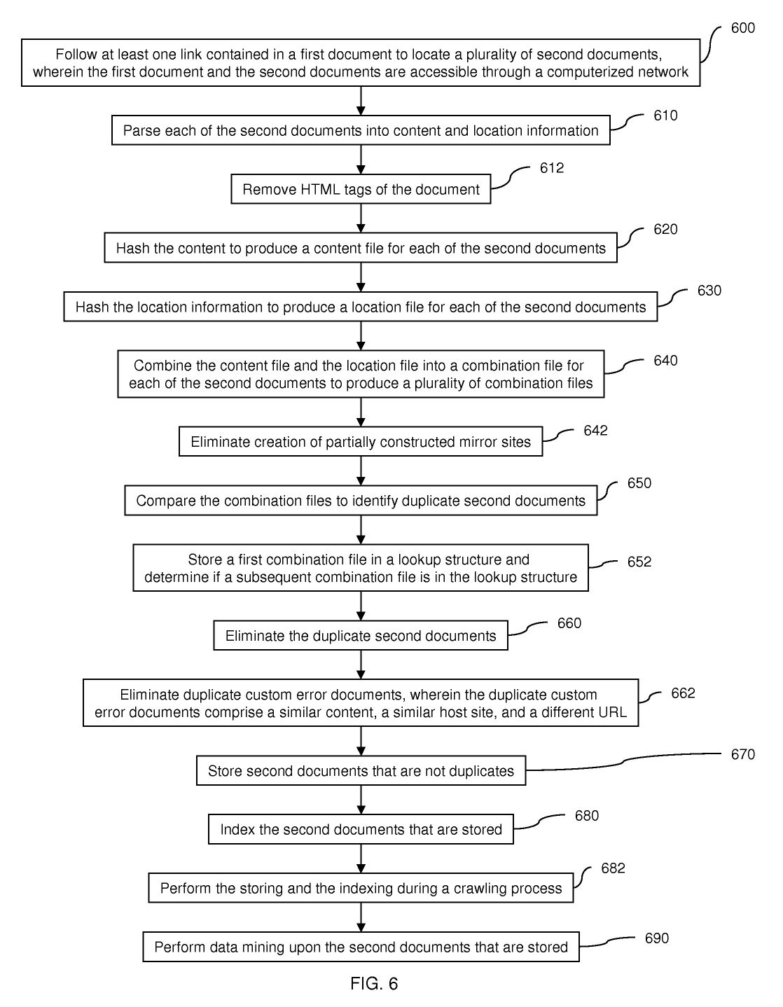

FIG. 6 is a diagram illustrating a method for online duplicate detection and elimination in a web crawler. The method begins in item 600 by following at least one link contained in a first document to locate a plurality of second documents, wherein the first document and the second documents are accessible through a computerized network. The computerized network could be the Internet and the documents could be electronic documents or websites. In item 610, each of the second documents is parsed into content and location information; and in item 622, HTML tags of the document are removed.

Next, in item 620, the content is hashed to produce a content file (also referred to herein as a “fingerprint”) for each of the second documents. The location information is also hashed in item 630 to produce a location file (also referred to herein as a “host hash”) for each of the second documents. Following this, in item 640, the content file and the location file are combined into a combination file (also referred to herein as a “tuple”) for each of the second documents to produce a plurality of combination files. As described above, the tuple consisting of the host hash and fingerprint is used instead of just the fingerprint to do the checks. If just the fingerprint of the page were used, it would have arbitrarily eliminated a lot of cross page duplicates, thereby resulting in incoherent data.

The combining of the content file and the location file can include eliminating (avoid) the creation of partially constructed mirror sites in item 642. As described above, the essence of considering (host hash, fingerprint) tuple in duplicate detection at crawl time is that it avoids construction of partially mirrored sites in a backend repository. For example, there are two sites which are mirror/partial mirrors of each other. The crawler detects those and starts to crawl independent parts of the sites. If the cross site duplicate detection is implemented, then both the sites may be partially crawled, wherein some parts are declared as duplicates of the other. Embodiments herein independently crawl both the mirror sites completely, wherein only the duplicate pages are removed from the same host.

The combination files are compared to identify duplicate second documents in item 650. This can include, in item 652, storing a first combination file in a lookup structure and determining if a subsequent combination file is in the lookup structure. As described above, before the crawler writes a page to a store, this lookup structure is consulted. If the lookup structure already contains the tuple (i.e., host hash and fingerprint), then the page is not written to the store. Thus, a lot of duplicates are eliminated at the crawler itself, saving CPU and disk cycles which would otherwise be needed during current duplicate elimination processes. The duplicate second documents are subsequently eliminated in item 660. This can include, in item 662, eliminating duplicate custom error documents, wherein the duplicate custom error documents comprise a similar content, a similar content provider (host site), and a different URL.

The method further stores the second documents that are not duplicates in (item 670). Moreover, the method indexes the second documents that are stored in (item 680), wherein the storing and the indexing can be performed during a crawling process in (item 682). Additionally, data mining is performed upon the second documents that are stored in item 690.

Accordingly, as part of the normal crawling process, a crawler parses a page and computes a de-tagged hash, called a fingerprint, of the page content. A lookup structure consisting of the host hash (hash of the host portion of the URL) and the fingerprint of the page is maintained. Before the crawler writes a page to a store, this lookup structure is consulted. If the lookup structure already contains the tuple (i.e., host hash and fingerprint), then the page is not written to the store. Thus, a lot of duplicates are eliminated at the crawler itself, saving CPU and disk cycles which would otherwise be needed during current duplicate elimination processes.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method comprising:
following at least one link contained in a first document to locate a plurality of second documents, wherein said first document and said second documents are accessible through a computerized network;
parsing each of said second documents into content and location information;
hashing said content to produce a content file for each of said second documents;
hashing said location information to produce a location file for each of said second documents;
combining said content file and said location file into a combination file for each of said second documents to produce a plurality of combination files;
comparing said combination files to identify duplicate second documents;
eliminating said duplicate second documents;
storing ones of said second documents that are not duplicate second documents;
indexing said ones of said second documents that are stored; and
performing data mining upon said ones of said second documents that are stored.

2. The method according to claim 1, wherein said eliminating of said duplicate second documents eliminates duplicate custom error documents, wherein said duplicate custom error documents comprise a similar content, a similar content provider, and a different uniform resource locator (URL).

3. The method according to claim 1, wherein said combining of said content file and said location file comprises eliminating creation of partially constructed mirror sites.

4. The method according to claim 1, further comprising removing hypertext markup language (HTML) tags of said document.

5. The method according to claim 1, wherein said storing and said indexing are performed during a crawling process.

6. The method according to claim 1, wherein said comparing of said combination files to identify said duplicate documents comprises:
storing a first combination file in a lookup structure; and
determining if a subsequent combination file is in said lookup structure.

7. A method comprising:
following at least one link contained in a first web page to locate a plurality of second web pages, wherein said first web page and said second web pages are accessible through the Internet;
parsing each of said second web pages into content and location information;
hashing said content to produce a content file for each of said second web pages;
hashing said location information to produce a location file for each of said second web pages;
combining said content file and said location file into a combination file for each of said second web pages to produce a plurality of combination files;
comparing said combination files to identify duplicate second web pages;
eliminating said duplicate second web pages, comprising eliminating duplicate custom error web pages, wherein said duplicate custom error web pages comprise a similar content, a similar content provider, and a different uniform resource locator (URL);
storing ones of said second web pages that are not duplicate second web pages;
indexing said ones of said second web pages that are stored; and
performing data mining upon said ones of said second web pages that are stored.

8. The method according to claim 7, wherein said combining of said content file and said location file comprises eliminating creation of partially constructed mirror sites.

9. The method according to claim 7, further comprising removing hypertext markup language (HTML) tags of said web page.

10. The method according to claim 7, wherein said storing and said indexing are performed during a crawling process.

11. A system comprising:
a browser adapted to follow at least one link contained in a first document to locate a plurality of second documents, wherein said first document and said second documents are accessible through a computerized network;
a parser operatively connected to said browser, wherein said parser is adapted to parse each of said second documents into content and location information;
a hasher operatively connected to said parser, wherein said hasher is adapted to hash said content to produce a content file for each of said second documents, and wherein said hasher is adapted to hash said location information to produce a location file for each of said second documents;
a processor operatively connected to said hasher, wherein said processor is adapted to combine said content file and said location file into a combination file for each of said second documents to produce a plurality of combination files;
a comparator operatively connected to said processor, wherein said comparator is adapted to compare said combination files to identify duplicate second documents;
a filter operatively connected to said comparator, wherein said filter is adapted to eliminate said duplicate second documents;
a memory operatively connected to said filter, wherein said memory is adapted to store ones of said second documents that are not duplicate second documents;
an indexer operatively connected to said memory, wherein said indexer is adapted to index said ones of said second documents that are stored; and
a data miner operatively connected to said indexer, wherein said data miner is adapted to perform data mining upon said ones of said second documents that are stored.

12. The system according to claim 11, wherein said filter is further adapted to eliminate duplicate custom error documents, wherein said duplicate custom error documents comprise a similar content, a similar content provider, and a different uniform resource locator (URL).

13. The system according to claim 11, wherein said filter is further adapted to eliminate creation of partially constructed mirror sites.

14. The system according to claim 11, wherein said hasher is further adapted to remove hypertext markup language (HTML) tags of said document.

15. The system according to claim 11, wherein said memory and said indexer are further adapted to perform said storing and said indexing during a crawling process.

16. The system according to claim 11, wherein said memory and said comparator are further adapted to:
store a first combination file in a lookup structure; and
determine if a subsequent combination file is in said lookup structure.

17. A system comprising:
a browser adapted to follow at least one link contained in a first web page to locate a plurality of second web pages, wherein said first web page and said second web pages are accessible through the Internet;
a parser operatively connected to said browser, wherein said parser is adapted to parse each of said second web pages into content and location information;
a hasher operatively connected to said parser, wherein said hasher is adapted to hash said content to produce a content file for each of said second web pages, and wherein said hasher is adapted to hash said location information to produce a location file for each of said second web pages;
a processor operatively connected to said hasher, wherein said processor is adapted to combine said content file and said location file into a combination file for each of said second web pages to produce a plurality of combination files;
a comparator operatively connected to said processor, wherein said comparator is adapted to compare said combination files to identify duplicate second web pages;
a filter operatively connected to said comparator, wherein said filter is adapted to eliminate said duplicate second web pages, and wherein said filter is further adapted to eliminate duplicate custom error web pages, wherein said duplicate custom error web pages comprise a similar content, a similar content provider, and a different uniform resource locator (URL);
a memory operatively connected to said filter, wherein said memory is adapted to store ones of said second web pages that are not duplicate second web pages;
an indexer operatively connected to said memory, wherein said indexer is adapted to index said ones of said second web pages that are stored; and
a data miner operatively connected to said indexer, wherein said data miner is adapted to perform data mining upon said ones of said second web pages that are stored.

18. The system according to claim 17, wherein said filter is further adapted to eliminate creation of partially constructed mirror sites.

19. The system according to claim 17, wherein said hasher is further adapted to remove hypertext markup language (HTML) tags of said web page.

20. The system according to claim 17, wherein said memory and said indexer are further adapted to perform said storing and said indexing during a crawling process.
